(19) United States
(12) Patent Application Publication
(10) Pub. No.: US 2025/0189656 A1
(43) Pub. Date: Jun. 12, 2025

(54) FEASIBILITY OF SENSING IN A SENSING-COMMUNICATION SYSTEM

(71) Applicant: QUALCOMM Incorporated, San Diego, CA (US)

(72) Inventors: Min HUANG, Beijing (CN); Jing DAI, Beijing (CN); Chao WEI, Beijing (CN); Hao XU, Beijing (CN)

(21) Appl. No.: 18/847,401

(22) PCT Filed: May 27, 2022
(86) PCT No.: PCT/CN2022/095560

§ 371 Date: Sep. 16, 2024

(51) Int. Cl. G01S 13/76; G01S 7/00

(52) U.S. Cl. CPC G01S 13/765; G01S 7/006

(57) ABSTRACT

Methods and apparatus for determining feasibility of sensing a target object in an integrated radio frequency (RF) system capable of sensing and communication are described. In some embodiments, a wireless network node (e.g., base station) may be configured to send or receive a communication signal with a communication UE, the sending or the receiving of the communication signal causing signal interference with a sensing UE; send to the sensing UE a sensing feasibility report configuration, which may include requirements associated with one or more radio frequency (RF) sensing metrics; receive from the sensing UE a sensing feasibility report, which may include information relating to the one or more RF sensing metrics given the signal interference; and based on the information relating to the one or more RF sensing metrics indicating a positive feasibility of sensing the target object, send an RF sensing reference signal toward the target object.

### BACKGROUND

### 1. Field of Disclosure

The present disclosure relates generally to the field of wireless communications, and more specifically to configuring sensing metrics and requirements to sensing user equipment (UE) in an integrated radio frequency (RF) sensing and communication (ISAC) system.

### 2. Description of Related Art

Integrated sensing and communication (ISAC) is regarded as a technique used with 5G (fifth generation) cellular communication systems and beyond, such as Third Generation Partnership Project (3GPP) standards that provide enhanced support for ISAC (such as “5G-Advanced” based on, e.g., 3GPP Release 18) or 6G (sixth generation) systems. ISAC may have cost advantages from shared radio frequency (RF) and/or baseband hardware for transmitting both communication and radio sensing signals. ISAC may also have spectrum efficiency in utilizing congested wireless resources for both communication and sensing functions, e.g., by utilizing space-division. ISAC technology can enable communications infrastructures to provide sensing functionalities with minimal system modifications, which would allow existing communication networks to provide sensing and surveillance services. As a result, various use cases can be made available for ISAC, including macro sensing (e.g., meteorological monitoring, autonomous driving, cartographic dynamic mapping, managing low-altitude airspace (using, e.g., unmanned aerial vehicles (UAVs)), intruder detection), micro sensing (e.g., gesture recognition, signal detection for user vitals, high-resolution terahertz (THz) imaging), and sensing-assisted communication (e.g., beam management).

### BRIEF SUMMARY

In one aspect of the present disclosure, a method of determining a feasibility of sensing a target object is disclosed. In some embodiments, the method is performed in a radio frequency (RF) sensing system having a communication user equipment (UE) and a sensing UE, and the method includes: sending or receiving a communication signal with the communication UE, the sending or the receiving of the communication signal causing signal interference with the sensing UE; sending to the sensing UE a sensing feasibility report configuration, the sensing feasibility report configuration including requirements associated with one or more RF sensing metrics; receiving from the sensing UE a sensing feasibility report, the sensing feasibility report including information relating to the one or more RF sensing metrics given the signal interference; and based on the information relating to the one or more RF sensing metrics indicating a positive feasibility of sensing the target object, sending an RF sensing reference signal toward the target object.

In another aspect of the present disclosure, a wireless base station is disclosed. In some embodiments, the wireless base station includes: a transceiver configured to perform data communication with a communication user equipment (UE) and a sensing UE; memory; and one or more processors communicatively coupled to the transceiver and the memory, and configured to: send or receive a communication signal with the communication UE, the sending or the receiving of the communication signal causing signal interference with the sensing UE; send to the sensing UE a sensing feasibility report configuration, the sensing feasibility report configuration including requirements associated with one or more radio frequency (RF) sensing metrics; receive from the sensing UE a sensing feasibility report, the sensing feasibility report including information relating to the one or more RF sensing metrics given the signal interference; and based on the information relating to the one or more RF sensing metrics indicating a positive feasibility of sensing the target object, send an RF sensing reference signal toward the target object.

In another aspect of the present disclosure, a non-transitory computer-readable apparatus is disclosed. In some embodiments, the non-transitory computer-readable apparatus includes a storage medium, the storage medium including a plurality of instructions configured to, when executed by one or more processors, cause a sensing user equipment (UE) to: receive a sensing feasibility report configuration from a base station, the sensing feasibility report configuration including requirements associated with one or more radio frequency (RF) sensing metrics; detect signal interference based on communication between the base station and a communication UE; generate a sensing feasibility report including information relating to the one or more RF sensing metrics given the signal interference and indicating a feasibility of sensing a target object; and send the sensing feasibility report to the base station.

In another aspect of the present disclosure, a sensing user equipment (UE) is disclosed. In some embodiments, the sensing UE includes: means for receiving a sensing feasibility report configuration from a base station, the sensing feasibility report configuration including requirements associated with one or more radio frequency (RF) sensing metrics; means for detecting signal interference based on communication between the base station and a communication UE; means for generating a sensing feasibility report including information relating to the one or more RF sensing metrics given the signal interference and indicating a feasibility of sensing a target object; and means for sending the sensing feasibility report to the base station.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a block diagram of example hardware configured for sensing and communication.

FIG. 4 is a diagram of a bistatic system configured for sensing a target object in a wireless communications environment, according to some embodiments.

FIG. 5 is a diagram of an integrated sensing and communication (ISAC) system in which a transmitter is configured to transmit a communication signal to a communication user equipment (UE), and a sensing reference signal to a sensing UE, according to some embodiments.

FIG. 6 is a diagram of the ISAC system of FIG. 5 in which the transmitter is configured to exchange specialized data with the sensing UE while under interference from one or more communication UEs, according to some embodiments.

FIG. 7 is a ladder diagram of a call flow for exchange of signals among a gNB, a communication UE, and a sensing UE, communicative in a wireless network such as that shown in FIG. 1 or 2, and implemented in a network environment or ISAC system such as that shown in FIG. 4, 5, or 6, according to some embodiments.

FIG. 8 is a flow diagram of a method of determining a feasibility of sensing a target object in an RF system having a communication UE and a sensing UE, according to some embodiments.

FIG. 9 is a flow diagram of another method of determining a feasibility of sensing a target object in an RF system having a communication UE and a sensing UE, according to some embodiments.

FIG. 10 is a block diagram of an embodiment of a UE, which can be utilized in embodiments as described herein.

FIG. 11 is a block diagram of an embodiment of a base station, which can be utilized in embodiments as described herein.

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects are detected using RF signals transmitted by a transmitting device and, after reflecting from the one or more objects, received by a receiving device. In a monostatic configuration, the transmitting and receiving device are the same device. In multi-static configuration, one or more receiving devices are separate from one or more transmitting devices. As described hereafter in more detail, a receiving device can make measurements of these reflected RF signals to determine one or more characteristics of the one or more objects, such as location, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF sensing with frequencies outside this range. For example, in some embodiments, 5G NR frequency bands (e.g., 28 GHZ) may be used. Because RF sensing may be performed in the same bands as communication, hardware may be utilized for both communication and RF sensing. For example, one or more of the components of a RF sensing system as described herein may be included in a wireless modem (e.g., Wi-Fi or NR modem), a mobile network base station, or the like. Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects of wireless communication.

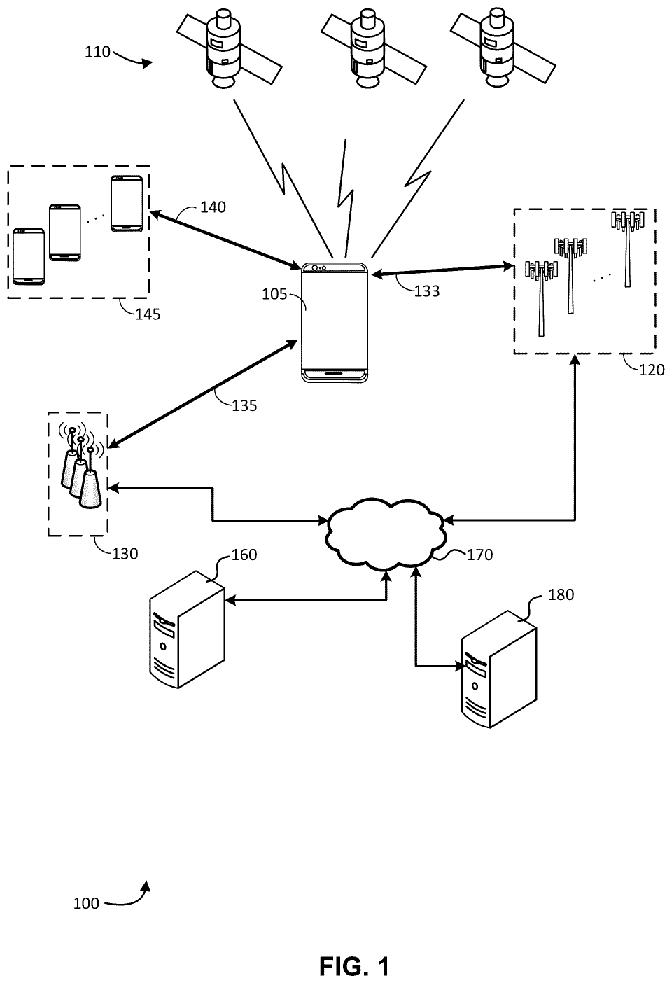

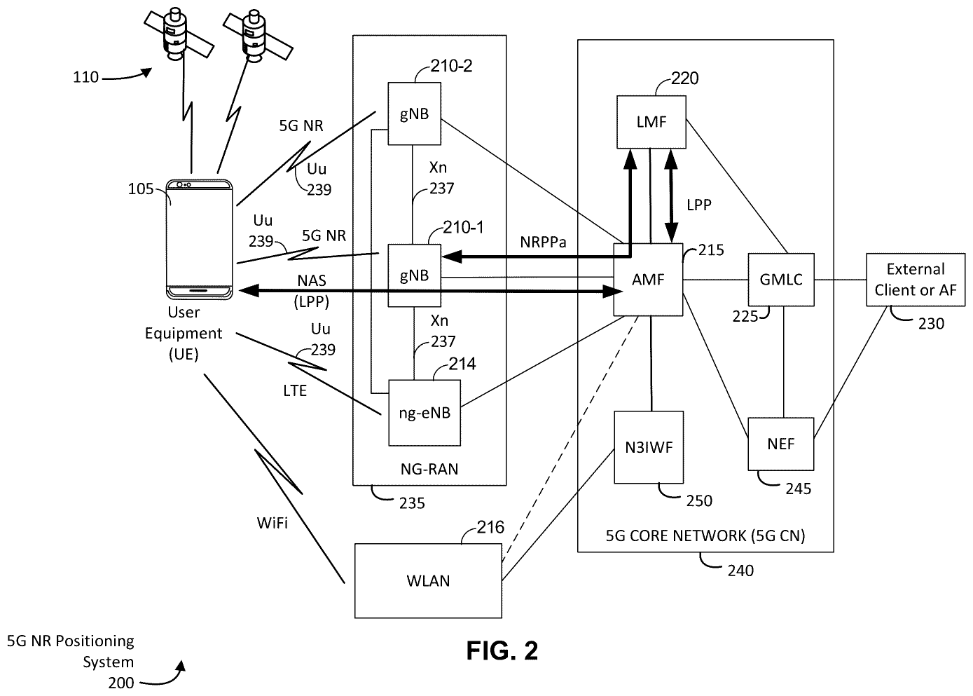

FIG. 1 is a simplified illustration of a positioning system 100 in which a UE 105, location server 160, and/or other components of the positioning system 100 can use the techniques provided herein for, e.g., determining a sensing feasibility of a UE 105, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5 GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

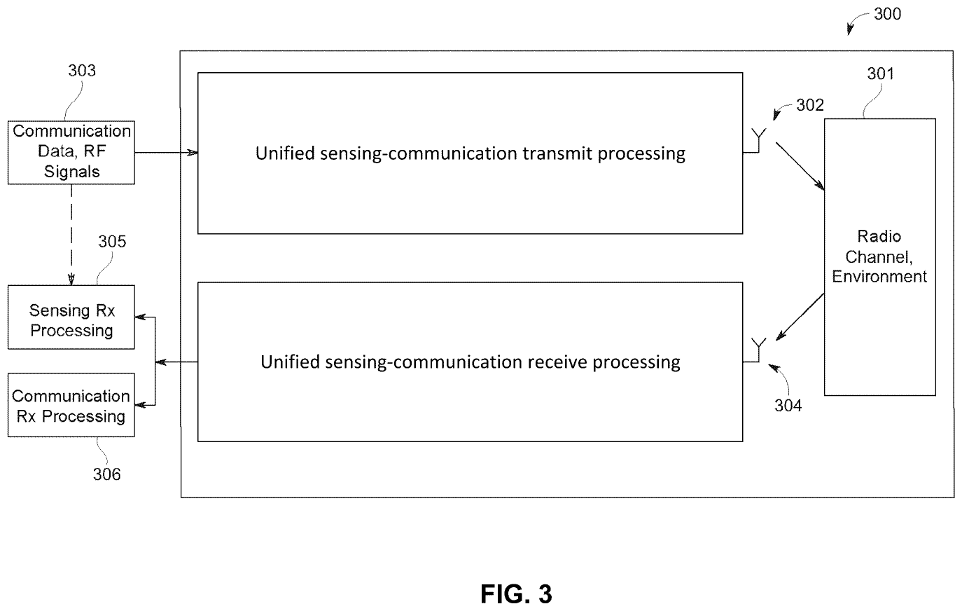

FIG. 3 illustrates a block diagram of example hardware 300 configured for sensing and communication. In some implementations, the example hardware 300 may be disposed at a base station (e.g., base station 120, gNB 210) within an integrated sensing and communication (ISAC) system. Circuit components for unified sensing-communication transmit processing associated with antenna(s) 302 may be configured to transmit data or signals 303 (e.g., communication or sensing reference signals generated by the base station) in a communication environment 301 (e.g., within positioning system 100, network 200), and circuit components for unified sensing-communication receive processing associated with antenna(s) 304 may be configured to receive the data or signals (e.g., communication or sensing reference signals), demodulate communication signals (e.g., by a communication receive processing module 306), and the demodulate RF sensing signals (e.g., by at least a RF sensing processing module 305). The circuit components of the example hardware 300 may be shared as shown so as to enable transmission and receipt of either communication signals or sensing signals. In some cases, the example hardware 300 may enable the base station to perform transmission and receipt simultaneously, e.g., simultaneous transmission of communication and sending signals.

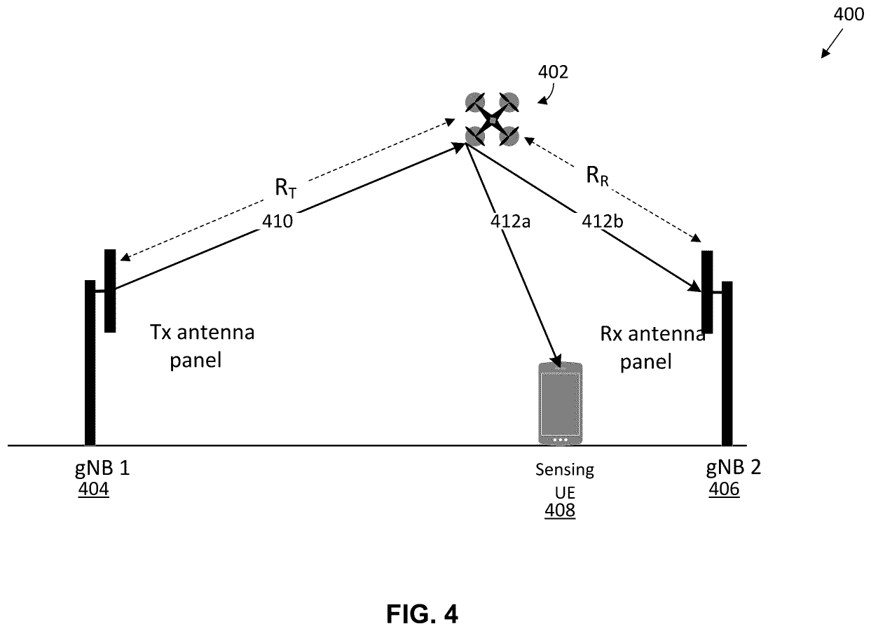

FIG. 4 illustrates a diagram of a bistatic communication system 400 configured for sensing a target object 402 in a wireless communications environment, according to some embodiments. In some embodiments, the target object may be a vehicle, including an unmanned aerial vehicle (UAV). The wireless communications environment may include a transmitter 404, a receiver 406, and a sensing user equipment (UE) 408. In some implementations, the transmitter 404 and the receiver 406 may each include a base station, e.g., gNB 1 and gNB 2, respectively, as depicted in FIG. 4. The sensing UE 408 may be configured to receive a reflection signal 412a of the sensing reference signals 410 and information associated therewith. In some scenarios, a position or an estimated or approximate position of the sensing UE 408 may be known to the transmitting gNB 404. In some scenarios, the position of the sensing UE may be unknown. However, in such scenarios, sensing feasibility may still be possible, e.g., according to blocks 810 and/or 820, or blocks 910-940, described below.

In a bistatic communication system such as 400, the transmitter 404 may send a sensing reference signal 410 which traverses a distance RT to reach target object 402. The sensing reference signal 410 may reflect from the target object 402 and become a reflection signal 412, which traverses a distance RR to reach the receiver 406 (e.g., receiving gNB 406) or the sensing UE 408. A primary function served by a bistatic communication system is sensing the range, or distance RR, from the target object 402 to the receiving device, e.g., the sensing UE 408. In some implementations, the bistatic system may determine the range RR by determining the amount of time taken for the sensing signal 410 and reflection signal 412 to traverse the total distance Rₛᵤₘ, which is the sum of RT and RR. The total distance Rₛᵤₘ may define an ellipsoid surface (also known as an iso-range contour) with foci at the locations of the transmitter 404 and the receiving device (e.g., sensing UE 408), respectively. The ellipsoid surface represents all the possible locations of the target object 402, given the total distance Rₛᵤₘ. If perfect synchronization of timing between the transmitter 404 and the sensing UE 408 can be assumed, it would be easy to simply measure the time duration Tₛᵤₘ between moment when the transmitter 404 sent the transmit signal 410 and moment when the sensing UE 408 received the reflection signal 412a. Tₛᵤₘ may be determined based on a difference in time information, e.g., between a transmit timestamp in the sensing reference signal and a receive timestamp at the sensing UE 408. Multiplying the time duration Tₛᵤₘ by the speed of the signal through free space, e.g., approximately c=3*108 meters/second, would yield Rₛᵤₘ. Thus, the ellipsoid surface of all possible locations of the target object 402 can be found by measuring the “flight time” Tₛᵤₘ of the sensing reference signal.

For example, the transmitting gNB 404 may emit a sensing reference signal 410, which may interact with the target object 402 (e.g., a UAV). Upon interaction, the sensing reference signal 410 may reflect (or refract in some cases, such as if the RF wave of the sensing reference signal passes from one medium to another, e.g., underwater to air or vice versa). The sensing UE 410 may detect the reflected reflection signal 412a of the sensing reference signal 410, and determine information about the target object 402 given one more determinations of metrics such as Rₛᵤₘ. Such information may include estimated location, direction of location, speed, direction of movement of the target object 402. Additional metrics may be considered in conjunction with Rₛᵤₘ, such as the direction of arrival (DoA), angle of arrival (AoA), time difference of arrival (TDOA), or a combination thereof. In some implementations, the receiving gNB 406 may also detect the reflection signal 412b of the sensing reference signal 410, and determine information about the target object 402 based on the same metrics.

An advantage of such a bistatic communication system (utilizing a transmitter and a receiver) or a multi-static communication system (utilizing more than one transmitter and one receiver) is that there is no need to mitigate self-interference. That is, since the sensing reference signal and the reflected sensing signal are not transmitted by and received at the same transmitter-receiver apparatus (e.g., base station, gNB) as they would in a monostatic communication system, self-interference does not occur in bistatic or multi-static communication systems.

However, interference may still occur in ISAC systems because of the coexistence of communication signals and sensing signals. For instance, interference may occur between a transmitter 404 and the sensing UE 408 because the transmitter 404 is also sending communication signals to a communication UE.

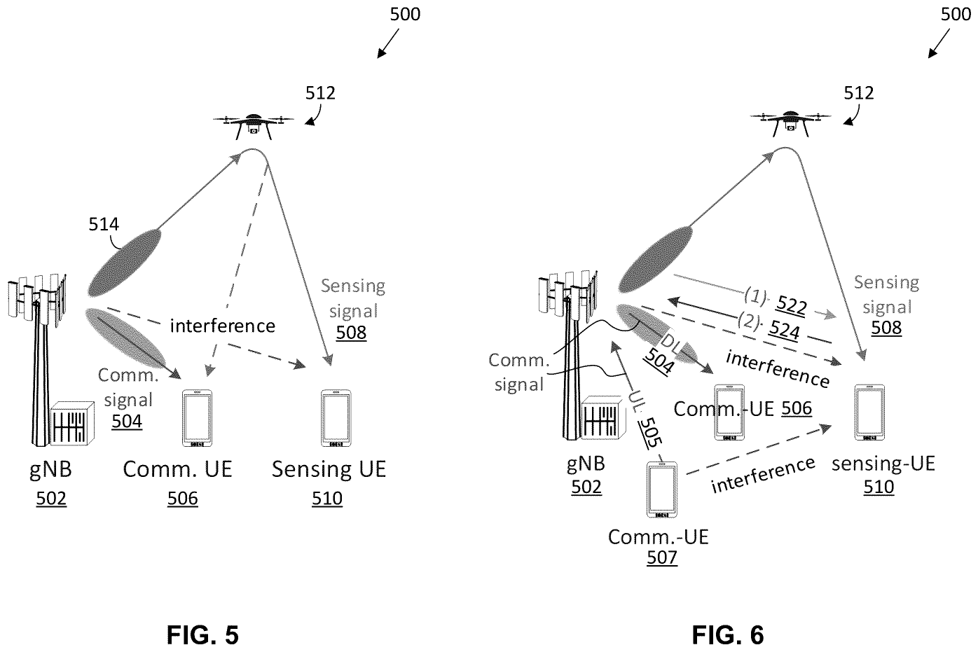

In an ISAC system, to improve spectrum efficiency and keep sensing signal consistent in the time domain (e.g., for Doppler estimation), communication signals and sensing signals can be scheduled using the same radio resource, e.g., using space-division multiplexing. FIG. 5 illustrates a diagram of an ISAC system 500 in which a transmitter 502 (e.g., gNB) is configured to transmit a communication signal 504 to a communication UE 506, and a sensing reference signal 508 to a sensing UE 510, according to some embodiments. In some cases, the sensing UE 510 is configured to receive the sensing reference signal 508 after the sensing reference signal 508 has interacted with (e.g., reflected from) a target object 512 (e.g., UAV).

In some embodiments, the ISAC system 500 assumes two conditions for proper operation. First, to effectuate the usage of the same radio resource, the beam 514 used to transmit the sensing reference signal 508 should be properly selected such that the signal data can be transmitted within the required time resource (e.g., time slot) while under interference from simultaneous deployment of communication signals 504 by the transmitter 502. For example, the communication UE 506 should be able to receive and/or report information (e.g., channel state information (CSI)) to the transmitter 502 with possible presence of interference from the sensing signal 508.

Second, the interference from communication signals exchanged with communication UEs, and sensing signals from possible sensing target positions should also be considered. The position of the sensing target (e.g., target object 512) is relatively unknown, hence the sensing. In some cases, possible estimated positions may be known to the sensing UE 510 based on, e.g., the longest distance of the target object and the transmit power of the sensing reference signal. The sensing UE 510 may then determine the possible minimum receive power of the sensing reference signal. Based on the minimum receive power, the sensing UE 510 may then be able to determine signal quality parameters, such as a signal-to-noise ratio (SNR) or Signal to Interference & Noise Ratio (SINR). Based on a defined relationship between a signal quality parameter and a sensing metric, such as ranging estimation error values, the sensing UE 510 may determine or estimate the ranging estimation error given the signal quality parameter. The ranging estimation error may be indicative of a measured distance error and hence influence the estimation of the range of the target object 512.

As an aside, relationships between a signal quality parameter (e.g., SNR) and ranging estimation error with respect to bandwidth of a signal (e.g., sensing reference signal) at a given signal frequency (e.g., 3.5 GHZ) can be determined using empirical data. These relationships may be based on additional assumptions, such as the monostatic-sensing radio channel, which is related to the downlink radio channel from gNB to the target object, the uplink radio channel from the target object to gNB, and a constant radar cross-section (RCS). RCS may have values such as 0.1 m² or 2 m², and may refer to a measure of how detectable an object is by RF signal, and may also be referred to as the electromagnetic signature of the object. A larger RCS indicates that an object is more easily detected. With a given signal bandwidth and RCS, the ranging estimation error increases as SNR or SINR decreases. As an example, the ranging estimation error should be less than 10 meters, if signal bandwidth is 100 MHz, RCS is 0.1 m², and SNR is-15 dB.

Nonetheless, the effect of interference for all possible target positions should be considered. More specifically, in certain embodiments, the transmitter 502 may be aware of the feasibility of sensing while under the interference from communication signal. Feasibility may be based on sensing metrics and requirements by the transmitter 502.

FIG. 6 illustrates a diagram of the ISAC system 500 of FIG. 5 in which the transmitter 502 (e.g., gNB) is configured to exchange specialized data with the sensing UE 510 while under interference from one or more communication UEs 506, 507, according to some embodiments. In some embodiments, the transmitter 502 (e.g., gNB) may send a first message 522 containing a “sensing feasibility report configuration.” The sensing feasibility report configuration may indicate to the sensing UE 510, for example, sensing metrics (including requirements) and/or communication reference signal resources (e.g., CSI-RS, SRS, Demodulation Reference Signal (DMRS), Phase Tracking Reference Signal (PTRS)).

CSI-RS may refer to a reference signal that is used in the downlink direction. CSI-RS may be used for channel sounding and used to measure the characteristics of a radio channel so that the base station (e.g., transmitter 502) can use correct modulation, code rate, beam forming, etc. Receiving UEs (e.g., communication UE 506, sensing UE 510) may use these reference signals to measure the quality of the downlink channel. The transmitter 502 may send CSI-RS to report channel status information, such as CSI-RSRP, CSI-RSRQ and CSI-SINR, for mobility and/or positioning procedures.

SRS may also be useful to perform positioning of a UE (e.g., communication UE 506, sensing UE 510). For instance, a UE may transmit an SRS that is received by a wireless network node such as the transmitter 502 (or another UE). In some cases, the UE may measure an AoD based on the SRS to identify a direction of the UE from the transmitter. In some cases, the transmitter 502 may measure an AoA based on the SRS to identify the direction. However, these measurements of, e.g., CSI-RS or SRS may be affected by noise or other types of interference affecting the sensing UE or the base station, which may impact the accuracy of sensing and/or positioning.

In some embodiments, the transmitter 502 may receive a second message 524 from the sensing UE 510, the second message 524 containing a “sensing feasibility report.” The sensing feasibility report may indicate, for example, whether and how the required sensing metrics can be supported under the given communication interference(s). To utilize space-division multiplexing of communication and sensing signals, the sensing UE 510 may be configured to use receive beamforming to mitigate the interference caused by downlink communication 504 with communication UE 506 and/or uplink communication 505 with communication UE 507.

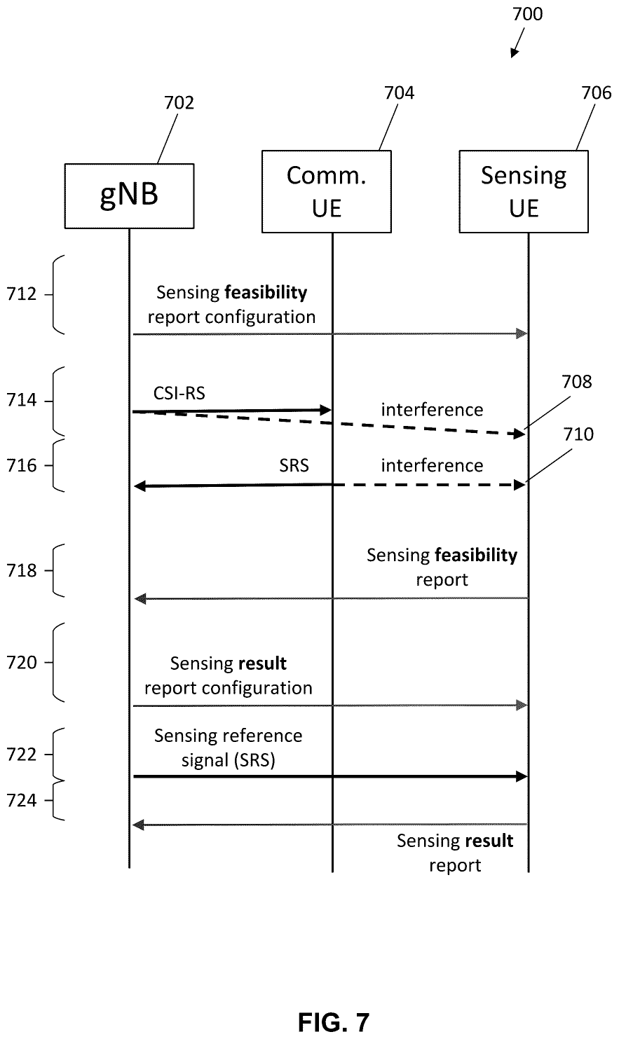

FIG. 7 is a ladder diagram of a call flow 700 for exchange of signals among a gNB 702, a communication UE 704, and a sensing UE 706, communicative in a wireless network such as that shown in FIG. 1 or 2, and implemented in a network environment or ISAC system such as that shown in FIG. 4, 5, or 6, according to some embodiments. The gNB 702 may be an example of the transmitting gNB 404 of FIG. 4 or the transmitting gNB 502 of FIGS. 5 and 6. The communication UE 704 may be an example of the communication UE 506 or 507 of FIGS. 5 and 6. The sensing UE 706 may be an example of the sensing UE 408 of FIG. 4 or the sensing UE 510 of FIGS. 5 and 6.

In some scenarios, the network environment may be under interference. For example, there may be interference 708 of signaling between the gNB 702 and the sensing UE 706, caused by communication between the gNB 702 and the communication UE 704. In some cases, there may be interference from communication with multiple communication UEs. There may be interference 710 of signaling between the communication UE 704 and the sensing UE 706, caused by communication between the gNB 702 and the sensing UE 706.

At step 712 of the call flow 700, the gNB 702 may send a message containing a sensing feasibility report configuration to the sensing UE 706. In some embodiments, the sensing feasibility report configuration may indicate sensing metrics and requirements. Examples of such sensing metrics may include a miss-detection ratio (which may refer in this context to a probability that a UE misses another UE's presence because of noise and channel fading), false-alarm ratio, mean-square error (MSE) or mean squared deviation (MSD) of one or more sensing metrics (e.g., distance estimation error, speed estimation error, Doppler frequency estimation error, micro-Doppler frequency estimation error), or a combination thereof. MSE may be determined

$$\frac{1}{n} {\sum }_{i = 1}^{n} {( {Y}_{i} - {\hat{Y}}_{i} )}^{2} ,$$

where n=number of samples, and (Yᵢ−Ŷᵢ)² is the square of the difference between an observed error and a predicted error.

Each of these sensing metrics may have a requirement, such as an acceptable upper or lower threshold or range requirements that the sensing UE 706 needs to meet in order to perform sensing adequately for a particular sensing instance for a target object that is to be sensed (e.g., 402, 512). The sensing feasibility report configuration may also indicate communication reference signal resources and/or format of, e.g., CSI-RS (step 712), SRS (step 714), DMRS, and/or PTRS, as reference metrics for potentially occurring interference.

In some implementations, the gNB 702 may configure a set of multiple profiles each indicating one or more predefined sensing metrics and requirements, and send the profiles to all sensing UEs, including sensing UE 706, via, e.g., the sensing feasibility report configuration message that includes the profile information. Because 5G and 6G networks are configured to use multi-static (including bistatic) sensing to improve sensing performance, in many cases, multiple sensing UEs may be involved in sensing a target object. In such cases, sensing metrics and requirements can be different for each of these multiple sensing UEs depending on, e.g., their individual radio channel statuses, capabilities, or environments. In addition, the payload of the “soft” information in the sensing feasibility report can sometimes be large and require usage of bandwidth and/or other resources (e.g., spectrum, time slots), so having multiple profiles for multiple sensing UEs may assist the gNB 702 in assigning and selecting the proper sensing UEs for sensing tasks, including when interference from communication to sensing exists, arising from communication between gNB and communication UEs.

For example, a first profile may define a distance with 1 meter MSE and a speed with 1 m/s MSE; a second profile may define a distance with 1 meter MSE and a speed with 10 m/s MSE; a third profile may define a distance with 10 meters MSE and a speed with 1 m/s MSE; and a fourth profile may define a distance with 10 meters MSE and a speed with 10 m/s MSE. Sensing UEs that return a positive determination of feasibility of sensing the target object for certain profile(s) may then be assigned for sensing the target object. For instance, the gNB 702 can send a sensing feasibility report configuration to those selected sensing UEs and/or send sensing reference signals with an expectation of receiving sensing metrics from those selected sensing UEs.

At step 714 of the call flow 700, in some implementations, the gNB 702 may send downlink CSI-RS to the communication UE 704, which may cause interference 708 with the sensing UE 706, e.g., for sending a sensing reference signal to the sensing UE 706. At step 716, in some implementations, the gNB 702 may receive uplink SRS from the communication UE 704, which may cause interference 710 with the sensing UE 706. CSI-RS and SRS may be useful for reasons stated elsewhere above.

At step 718 of the call flow 700, the gNB 702 may receive a sensing feasibility report from the sensing UE 706. In some embodiments, the sensing UE 706 may measure the interference (e.g., interference 708 and 710) and generate the sensing feasibility report based thereon. In some embodiments, the sensing feasibility report may be sent to the gNB 702 via Uplink Control Information (UCI) messages, which support uplink shared channel (UL-SCH) transmissions. In some embodiments, the sensing feasibility report may be sent to the gNB 702 via UL Radio Resource Control (UL RRC) signaling.

In some embodiments, the sensing feasibility report may indicate information relating to feasibility of sensing given the interference. In some implementations, the sensing feasibility may be indicated using one or more discrete determinations of sensing feasibility. For example, “hard” values such as 1 or 0, feasible or unfeasible, yes or no, and the like, where “1”, “feasible” and “yes” indicate a positive feasibility of sensing the target object or a high likelihood of sensing the target object (e.g., with respect to a threshold likelihood), and “0”, “unfeasible” and “no” indicate a negative feasibility of sensing the target object or a low likelihood of sensing the target object (e.g., with respect to a threshold likelihood), may be determined for each sensing metric noted above with respect to the sensing feasibility report configuration at step 712. In some implementations, the sensing feasibility may be indicated using one or more derivative determinations of sensing feasibility. “Soft” values such as the MSE of a sensing metric may be determined. For example, different SNR or SINR values can lead to different MSE values of distance estimations; that is, sensing metrics such as ranging estimation errors may continuously vary according to SNR or SINR. By obtaining multiple error data points and predicted errors, the MSE may be determined. In specific embodiments, the sensing UE 706 may determine the MSE of ranging estimation error based on SNR measured, signal bandwidth, and the RCS of the target object (e.g., 0.1 m² or 2 m²).

In some embodiments, the sensing feasibility report may indicate the preferred CSI-RS resource indicator (CRI), Precoding Matrix Indicator (PMI), Rank Indicator (RI) for downlink communication, or transmit precoding matrix index (TPMI) required for uplink scheduling, or SRS resource indicator (SRI) for uplink communication, or a combination thereof.

Assuming that the feasibility as indicated by the sensing feasibility report from the sensing UE 706 meets one or more criteria, the call flow 700 may proceed to step 720. In some embodiments, the one or more criteria may be a “hard” value of 1, feasible, yes, etc. Meeting the one or more criteria may indicate that sensing of the target object is feasible given the interference with the communication UE(s) 704, based on the sensing metrics requirements being met by the sensing UE 706.

In some embodiments, the one or more criteria may include a prescribed requirement or a range of sensing metrics (particularly in the case of, e.g., “soft” MSE values). For instance, if the ranging estimation error is above 10 m, sensing of a particular target object may be deemed not feasible. On the other hand, if the ranging estimation error is 10 m or less, the sensing of the particular target object may be deemed feasible. In some implementations, there may be more than two outcomes: If the ranging estimation error is 10 m or less, the sensing may be deemed feasible; above 100 m, sensing may be deemed not feasible; and between 10 and 100 m, sensing may be deemed potentially feasible and may require evaluation of additional sensing metrics. MSE or MSD of sensing metrics, such as distance estimation error, speed estimation error, Doppler frequency estimation error, or micro-Doppler frequency estimation error associated with the target object or parts thereof (e.g., a rotating blade of a UAV) may be taken into account in determining feasibility of sensing. If the target object is a moving object, e.g., a UAV, the foregoing sensing metrics may be important factors for sensing. Doppler frequency can be indicative of “bulk motion” of the target object as a whole, while micro-Doppler frequency can be indicative of “micro-motions” of parts of the target object (e.g., movement of the rotating blade of the UAV, oscillating arms of a walking person). If the target object is too far or moving away too fast as indicated by, e.g., an increase in Doppler frequency (or its estimation error) above an acceptable threshold or range, the sensing feasibility report may indicate such information and/or a determination that sensing is likely not feasible given the ranging estimation error that is between 10 and 100 m. However, in another scenario, the sensing feasibility report may indicate that sensing is likely feasible despite the out-of-range Doppler frequency estimation error, if the ranging estimation error is below 10 m. Myriad combinations of factors, e.g., sensing metrics, may account for the sensing feasibility. This type of feasibility information may enable the ISAC system to allocate resources (e.g., time slots) only when deploying sensing reference signals is likely to result in successful sensing and/or positioning of the target object, and conserve resources where feasibility is insufficient.

If the sensing feasibility report indicates that the sensing is not feasible, call flow 700 may end or return to step 712.

Returning to step 720 of the call flow 700, if sensing is determined to be feasible or likely feasible, the gNB 702 may send a sensing result report configuration to the sensing UE 706. It is noted that the sensing result report configuration is different from the sensing feasibility report configuration from step 712. The sensing result report configuration may be sent based on the received sensing feasibility report from step 718, or more specifically, based on an indication of feasibility of sensing in the interference environment. In some embodiments, the sensing result report configuration may include the required sensing metrics as measured by the sensing UE 706 (e.g., one or more of ranging estimation error, distance estimation error, speed estimation error, Doppler frequency estimation error, micro-Doppler estimation error) and/or sensing RS resources measured or configured by the communication UE 704 (e.g., CSI-RS, SRS).

At step 722 of the call flow 700, the gNB 702 may send a sensing reference signal to the sensing UE 706. The sensing reference signal may be an example of the sensing reference signal 410, and received by the sensing UE 706 as the reflection signal 412a, as depicted in FIG. 4, or the sensing reference signal 508 as depicted in FIGS. 5 and 6. The sensing reference signal may assist in positioning of the target object.

At step 724 of the call flow 700, the gNB 702 may receive a sensing result report from the sensing UE 706. In some embodiments, the sensing result report may include an estimation of sensing metrics based on the sensing reference signal, e.g., an estimated distance or speed of the target object. The estimated distance or speed may be based on Doppler frequency, or a micro-Doppler signature associated with “micro-motions” of the target object (e.g., movement of a blade of a UAV).

### Methods

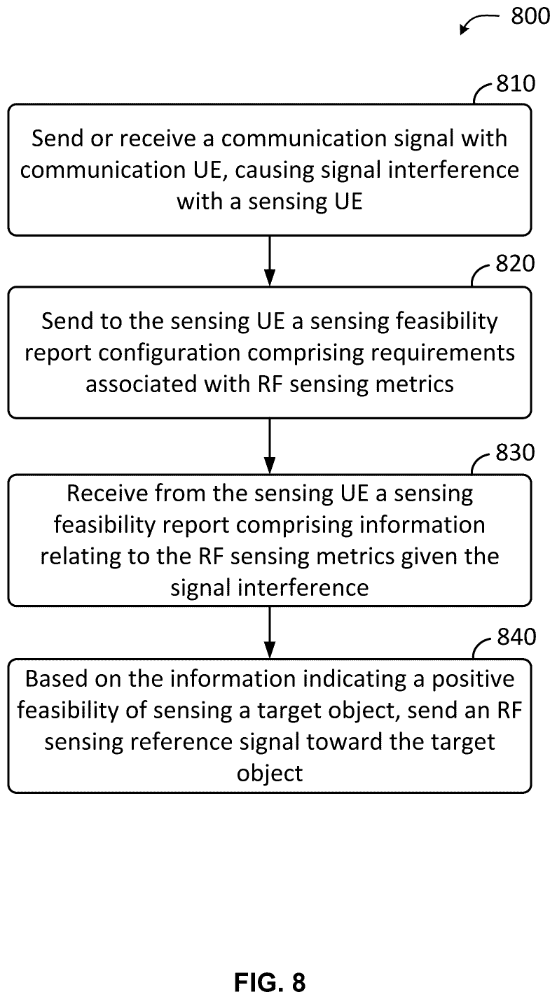

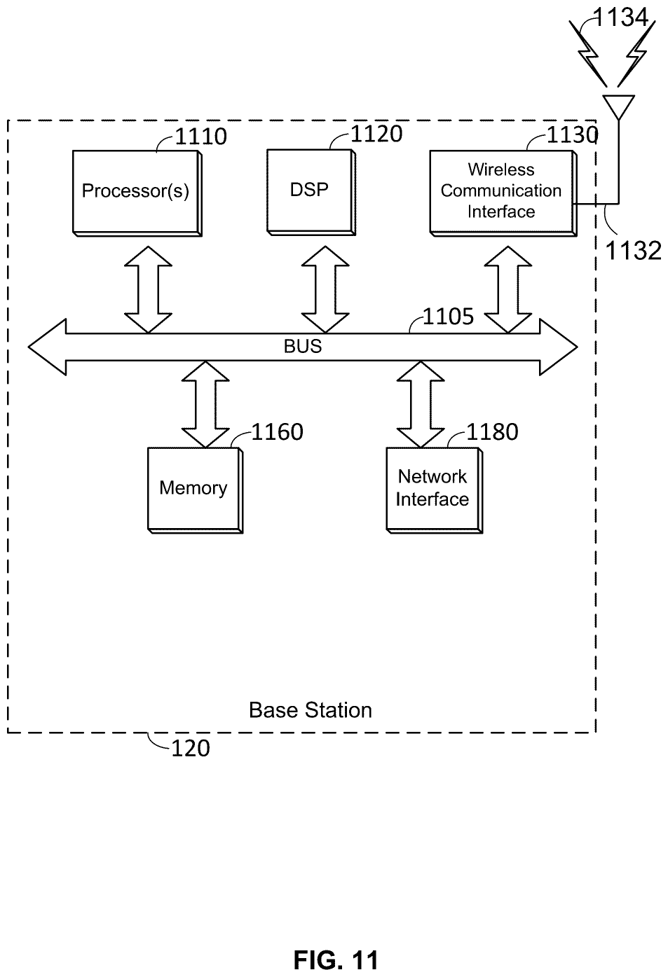

FIG. 8 is a flow diagram of a method 800 of determining a feasibility of sensing a target object in an RF system having a communication UE and a sensing UE, according to some embodiments. Means for performing the functionality illustrated in one or more of the blocks shown in FIG. 8 may be performed by hardware (e.g., processor(s)) and/or software components of a base station (e.g., gNB), or a computer-readable apparatus including a storage medium storing computer-readable and/or computer-executable instructions that are configured to, when executed by a processor apparatus, cause the at least one processor apparatus or computerized apparatus (e.g., the base station) to perform the operations. Example components of the base station are illustrated in FIGS. 11, which are described in more detail below.

It should also be noted that the operations of the method 800 may be performed in any suitable order, not necessarily the order depicted in FIG. 8. Further, the method 800 may include additional or fewer operations than those depicted in FIG. 8 to determine the feasibility.

At block 810, the method 800 may include sending or receiving a communication signal with the communication UE. In some scenarios, a base station (e.g., gNB) may send the communication signal to the communication UE. For example, a downlink reference signal (e.g., CSI-RS) may be sent to the communication UE. In some scenarios, the base station may receive the communication signal from the communication UE. For example, an uplink reference signal (e.g., SRS) may be received from the communication UE. In embodiments of an integrated sensing-communication system (e.g., ISAC system 500), the sending or receiving of the communication signal may cause signal interference, e.g., with a sensing UE.

At block 820, the method 800 may include sending to the sensing UE a sensing feasibility report configuration. In some embodiments, the sensing feasibility report configuration may include requirements associated with one or more RF sensing metrics. Examples of such RF sensing metrics may include a miss-detection ratio (which may refer in this context to a probability that a UE misses another UE's presence because of noise and channel fading), false-alarm ratio, mean-square error (MSE) or mean squared deviation (MSD) of one or more RF sensing metrics (e.g., distance estimation error, speed estimation error, Doppler frequency estimation error, micro-Doppler frequency estimation error), or a combination thereof. Each of these RF sensing metrics may have a requirement, such as an acceptable upper or lower threshold or range requirements that the sensing UE needs to meet in order to perform sensing adequately for a particular sensing instance for a target object that is to be sensed (e.g., 402, 512). Each of the one or more RF sensing metrics associated with the target object. The sensing feasibility report configuration may also indicate communication reference signal resources and/or format of, e.g., CSI-RS, SRS, DMRS, and/or PTRS, as reference metrics for potentially occurring interference.

At block 830, the method 800 may include receiving from the sensing UE a sensing feasibility report. In some embodiments, the sensing feasibility report may include information relating to the one or more RF sensing metrics given the signal interference. The information relating to the one or more RF sensing metrics may include measurements for one or more of the aforementioned RF sensing metrics.

At block 840, the method 800 may include, based on the information relating to the one or more RF sensing metrics indicating a positive feasibility of sensing the target object, sending an RF sensing reference signal toward the target object. Such positive feasibility of sensing may indicate to the base station that sending an RF sensing reference signal toward the target object will likely result usable information that will lead to sensing of the target object by the sensing UE.

In some implementations, the sensing feasibility may be indicated using one or more discrete determinations of sensing feasibility. For example, “hard” values such as 1 or 0, feasible or unfeasible, yes or no, and the like, where “1”, “feasible” and “yes” indicate a positive feasibility of sensing the target object or a high likelihood of sensing the target object (e.g., with respect to a threshold likelihood). That is, the positive feasibility of sensing the target object includes one of a binary determination of feasibility of sensing the target object.

In some implementations, the sensing feasibility may be indicated using one or more derivative determinations of sensing feasibility. “Soft” values such as the MSE of at least some of the one or more RF sensing metrics (e.g., distance estimation error, speed estimation error, Doppler frequency estimation error, micro-Doppler frequency estimation error) may be determined. The positive feasibility of sensing the target object may include at least one of the requirements associated with the one or more RF sensing metrics meeting or exceeding a prescribed threshold. Determination of the MSE may be performed using a defined relationship between a signal quality parameter (e.g., SNR, SINR) and an RF sensing metric (e.g., ranging estimation error). For example, since ranging estimation errors may continuously vary according to SNR, determining the SNR at the sensing UE, given other variables such as RCS and bandwidth, can allow determination of the corresponding ranging estimation error. MSE may then be determined by obtaining multiple error data points and predicted errors.

In some embodiments, if sensing is determined to be feasible or likely feasible, the base station may send a sensing result report configuration to the sensing UE, prior to the sending of the RF sensing reference signal to the sensing UE. The sensing result report configuration may include the required sensing metrics as measured by the sensing UE (e.g., one or more of ranging estimation error, distance estimation error, speed estimation error, Doppler frequency estimation error, micro-Doppler estimation error) and/or sensing RS resources measured or configured by the communication UE (e.g., CSI-RS, SRS).

In some embodiments, subsequent to the sending of the RF sensing reference signal to the sensing UE, the base station may receive a sensing result report from the sensing UE. In some embodiments, the sensing result report may include an estimation of sensing metrics based on the sensing reference signal, e.g., an estimated distance or speed of the target object. The estimated distance or speed may be based on Doppler frequency, or a micro-Doppler signature associated with “micro-motions” of the target object (e.g., movement of a blade of a UAV).

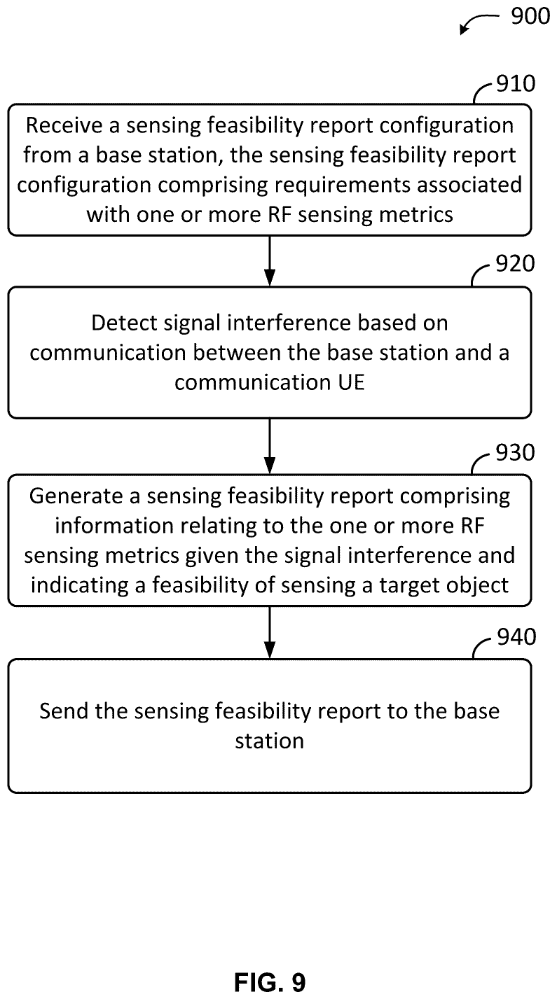

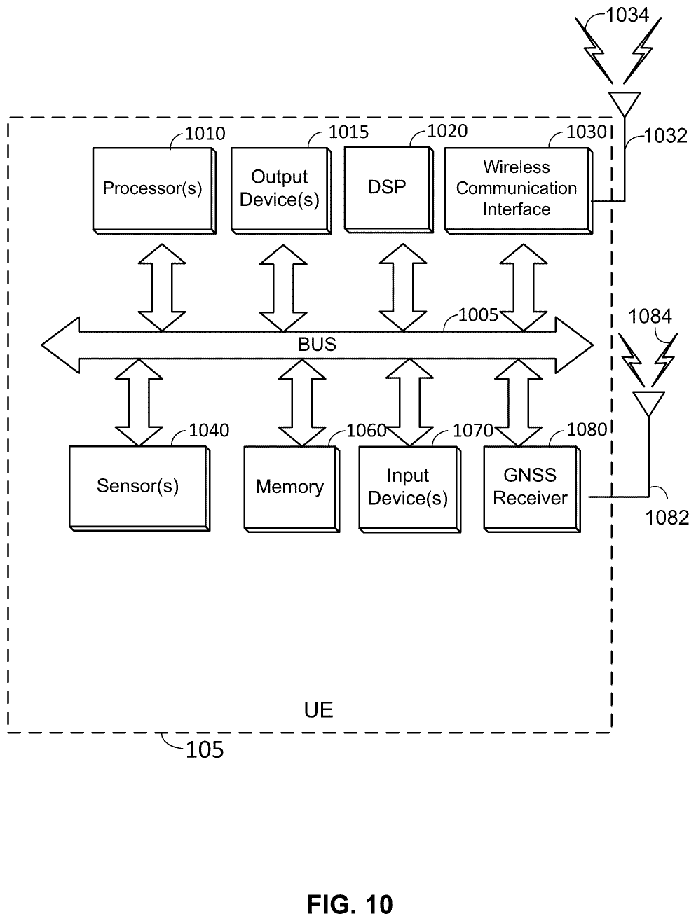

FIG. 9 is a flow diagram of another method 900 of determining a feasibility of sensing a target object in an RF system having a communication UE and a sensing UE, according to some embodiments. Means for performing the functionality illustrated in one or more of the blocks shown in FIG. 9 may be performed by hardware (e.g., processor(s)) and/or software components of a UE, or a computer-readable apparatus including a storage medium storing computer-readable and/or computer-executable instructions that are configured to, when executed by a processor apparatus, cause the at least one processor apparatus or computerized apparatus (e.g., the UE) to perform the operations. Example components of the UE are illustrated in FIGS. 10, which are described in more detail below.

It should also be noted that the operations of the method 900 may be performed in any suitable order, not necessarily the order depicted in FIG. 9. Further, the method 900 may include additional or fewer operations than those depicted in FIG. 9 to determine the feasibility.

At block 910, the method 900 may include receiving (e.g., at the sensing UE) a sensing feasibility report configuration from a base station (e.g., gNB), the sensing feasibility report configuration comprising requirements associated with one or more RF sensing metrics. Examples of such RF sensing metrics may include a miss-detection ratio (which may refer in this context to a probability that a UE misses another UE's presence because of noise and channel fading), false-alarm ratio, mean-square error (MSE) or mean squared deviation (MSD) of one or more RF sensing metrics (e.g., distance estimation error, speed estimation error, Doppler frequency estimation error, micro-Doppler frequency estimation error), or a combination thereof. Each of these RF sensing metrics may have a requirement, such as an acceptable upper or lower threshold or range requirements that the sensing UE needs to meet in order to perform sensing adequately for a particular sensing instance for a target object that is to be sensed (e.g., 402, 512). Each of the one or more RF sensing metrics associated with the target object.

At block 920, the method 900 may include detecting signal interference based on communication between the base station and a communication UE. In some embodiments, the signal interference may be detected via presence of other signals, such as CSI-RS (e.g., from base station to communication UE), SRS (e.g., from communication UE to base station), DMRS, and/or PTRS. The sensing UE may determine the presence of signal interference based on receipt of such signals. In some embodiments, the sensing UE may detect downlink signals from the base station to another UE (e.g., communication UE), or uplink signals from another UE (e.g., communication UE), indicating the presence of interference arising from communication between the base station and the other UE. In some embodiments, the base station may send a signal to the sensing UE indicating the use of communication hardware (e.g., antenna(s) 302) to perform data communication, e.g., during certain time slots coinciding with transmission of sensing signals. The sensing UE may infer the presence of interference based on this signal. In some embodiments, the sensing UE may observe that the current time is significantly delayed compared to a timestamp included in a signal received (if ever) from the base station or another UE. In some embodiments, the sensing UE may observe a lower signal quality parameter (e.g., SNR, SINR) as compared to a known signal quality parameter in non-interference scenarios. In some embodiments, the sensing UE may observe a lower downlink or uplink data transmission rate.

At block 930, the method 900 may include generating a sensing feasibility report comprising information relating to the one or more RF sensing metrics given the signal interference and indicating a feasibility of sensing a target object. In some embodiments, the information relating to the one or more RF sensing metrics may include measurements for one or more of the aforementioned RF sensing metrics.

In some embodiments, feasibility of sensing the target object may be indicated using one or more discrete determinations of sensing feasibility. In some implementations, the discrete determination may be a binary determination, e.g., 1 or 0, feasible or unfeasible, yes or no, and the like, where “1”, “feasible” and “yes” indicate a positive feasibility of sensing the target object or a high likelihood of sensing the target object (e.g., with respect to a threshold likelihood). In some implementations, the discrete determination may be indicated using one or more derivative determinations of sensing feasibility. “Soft” values such as the MSE of at least some of the one or more RF sensing metrics (e.g., distance estimation error, speed estimation error, Doppler frequency estimation error, micro-Doppler frequency estimation error) may be determined.

At block 940, the method 900 may include sending the sensing feasibility report to the base station.

In some embodiments, based on this sensing feasibility report, the base station may send a sensing result reportion configuration (including, e.g., required sensing metrics, as described elsewhere herein), and send a sensing reference signal toward the target object. In some embodiments, based on receipt of the sensing reference signal after interaction with the target object, the sensing UE may send a sensing result report (including, e.g., estimation of sensing metrics based on the sensing reference signal, as described elsewhere herein).

### Apparatus

FIG. 10 is a block diagram of an embodiment of a UE 105, which can be utilized as described herein above (e.g., in association with FIGS. 7-9). For example, the UE 105 can perform one or more of the functions of the method shown in FIG. 7 or 9. However, the UE may also be configured to enable one or more functions of the methods shown in FIG. 8, such as receiving a sensing feasibility report from the sensing UE (e.g., block 830). It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 10.

The UE 105 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The UE 105 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The UE 105 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1030 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1010 or DSP 1020.

The UE 105 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the UE 105 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the UE 105 (and/or processor(s) 1010 or DSP 1020 within UE 105). In some embodiments, then, such code and/or instructions can be used to configure and/or adapt a general-purpose computer (or other device) to perform one or more operations in accordance with the described methods.

FIG. 11 is a block diagram of an embodiment of a base station 120, which can be utilized as described herein above (e.g., in association with FIGS. 7-9). It should be noted that FIG. 11 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1105 (or may otherwise be in communication, as appropriate). The hardware elements may include a processor(s) 1110 which can include without limitation one or more general-purpose processors, one or more special-purpose processors (such as DSP chips, graphics acceleration processors, ASICs, and/or the like), and/or other processing structure or means. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1130 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1132 that send and/or receive wireless signals 1134.

The base station 120 may also include a network interface 1180, which can include support of wireline communication technologies. The network interface 1180 may include a modem, network card, chipset, and/or the like. The network interface 1180 may include one or more input and/or output communication interfaces to permit data to be exchanged with a network, communication network servers, computer systems, and/or any other electronic devices described herein.

In many embodiments, the base station 120 may further comprise a memory 1160. The memory 1160 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1160 of the base station 120 also may comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the base station 120 (and/or processor(s) 1110 or DSP 1120 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of determining a feasibility of sensing a target object in a radio frequency (RF) sensing system having a communication user equipment (UE) and a sensing UE, the method comprising: sending or receiving a communication signal with the communication UE, the sending or the receiving of the communication signal causing signal interference with the sensing UE; sending to the sensing UE a sensing feasibility report configuration, the sensing feasibility report configuration comprising requirements associated with one or more RF sensing metrics; receiving from the sensing UE a sensing feasibility report, the sensing feasibility report comprising information relating to the one or more RF sensing metrics given the signal interference; and based on the information relating to the one or more RF sensing metrics indicating a positive feasibility of sensing the target object, sending an RF sensing reference signal toward the target object.
Clause 2. The method of clause 1, further comprising: sending a sensing result report configuration to the sensing UE, the sensing result report configuration comprising the one or more RF sensing metrics; and receiving a sensing result report from the sensing UE, the sensing result report comprising one or more estimations corresponding to the one or more RF sensing metrics based on the RF sensing reference signal.
Clause 3. The method of any one of clauses 1-2 wherein the positive feasibility of sensing the target object comprises one of a binary determination of feasibility of sensing the target object.
Clause 4. The method of any one of clauses 1-3 wherein the positive feasibility of sensing the target object comprises at least one of the requirements associated with the one or more RF sensing metrics meeting or exceeding a prescribed threshold.
Clause 5. The method of any one of clauses 1-4 wherein the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object.
Clause 6. The method of any one of clauses 1-5 wherein the one or more RF sensing metrics associated with the target object are based at least on a signal quality parameter measured by the sensing UE.
Clause 7. The method of any one of clauses 1-6 wherein the information relating to the one or more RF sensing metrics comprises one or more corresponding estimation error values for the one or more RF sensing metrics associated with the target object.
Clause 8. The method of any one of clauses 1-7 wherein the sending of the communication signal with the communication UE comprises sending a downlink reference signal to the communication UE; and the receiving of the communication signal with the communication UE comprises receiving an uplink reference signal from the communication UE.
Clause 9. The method of any one of clauses 1-8 wherein the sending of the sensing feasibility report configuration comprises sending the sensing feasibility report configuration to a plurality of sensing UEs; the sensing feasibility report configuration comprises a plurality of profiles each defining one or more different requirements associated with at least a portion of the one or more RF sensing metrics; and the method further comprises selecting one or more of the plurality of sensing UEs for sensing the target object, the selecting based on the one or more different requirements indicating a sensing feasibility of the selected one or more of the plurality of sensing UEs.
Clause 10. A wireless base station comprising: a transceiver configured to perform data communication with a communication user equipment (UE) and a sensing UE; memory; and one or more processors communicatively coupled to the transceiver and the memory, and configured to: send or receive a communication signal with the communication UE, the sending or the receiving of the communication signal causing signal interference with the sensing UE; send to the sensing UE a sensing feasibility report configuration, the sensing feasibility report configuration comprising requirements associated with one or more radio frequency (RF) sensing metrics; receive from the sensing UE a sensing feasibility report, the sensing feasibility report comprising information relating to the one or more RF sensing metrics given the signal interference; and based on the information relating to the one or more RF sensing metrics indicating a positive feasibility of sensing a target object, send an RF sensing reference signal toward the target object.
Clause 11. The wireless base station of clause 10, wherein the one or more processors are further configured to: send a sensing result report configuration to the sensing UE, the sensing result report configuration comprising the one or more RF sensing metrics; and receive a sensing result report from the sensing UE, the sensing result report comprising one or more estimations corresponding to the one or more RF sensing metrics based on the RF sensing reference signal.
Clause 12. The wireless base station of any one of clauses 10-11 wherein the positive feasibility of sensing the target object comprises one of a binary determination of feasibility of sensing the target object.
Clause 13. The wireless base station of any one of clauses 10-12 wherein the positive feasibility of sensing the target object comprises at least one of the requirements associated with the one or more RF sensing metrics meeting or exceeding a prescribed threshold.
Clause 14. The wireless base station of any one of clauses 10-13 wherein the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object and based at least on a signal quality parameter measured by the sensing UE; and the signal quality parameter comprises a signal-to-noise ratio (SNR) or a Signal to Interference & Noise Ratio (SINR).
Clause 15. The wireless base station of any one of clauses 10-14 wherein the information relating to the one or more RF sensing metrics comprises one or more corresponding estimation error values for the one or more RF sensing metrics associated with the target object.
Clause 16. The wireless base station of any one of clauses 10-15 wherein the sending of the communication signal with the communication UE comprises sending of a downlink reference signal to the communication UE; and the receipt of the communication signal with the communication UE comprises receipt of an uplink reference signal from the communication UE.
Clause 17. The wireless base station of any one of clauses 10-16 wherein the sending of the sensing feasibility report configuration comprises sending of the sensing feasibility report configuration to a plurality of sensing UEs; the sensing feasibility report configuration comprises a plurality of profiles each defining one or more different requirements associated with at least a portion of the one or more RF sensing metrics; and the one or more processors are further configured to select one or more of the plurality of sensing UEs for sensing the target object, the selection based on the one or more different requirements indicating a sensing feasibility of the selected one or more of the plurality of sensing UEs.
Clause 18. A non-transitory computer-readable apparatus comprising a storage medium, the storage medium comprising a plurality of instructions configured to, when executed by one or more processors, cause a sensing user equipment (UE) to: receive a sensing feasibility report configuration from a base station, the sensing feasibility report configuration comprising requirements associated with one or more radio frequency (RF) sensing metrics; detect signal interference based on communication between the base station and a communication UE; generate a sensing feasibility report comprising information relating to the one or more RF sensing metrics given the signal interference and indicating a feasibility of sensing a target object; and send the sensing feasibility report to the base station.
Clause 19. The non-transitory computer-readable apparatus of clause 18, wherein the plurality of instructions are further configured to, when executed by the one or more processors, cause the sensing UE to: based on the feasibility of sensing the target object indicating a positive feasibility of sensing the target object: receiving an RF sensing reference signal originating from the base station; based on the RF sensing reference signal, determining an estimated sensing metric associated with the target object; and sending a sensing result report to the base station, the sensing result report comprising estimated sensing metric.
Clause 20. The non-transitory computer-readable apparatus of any one of clauses 18-19 wherein the positive feasibility of sensing the target object comprises one of a binary determination of feasibility of sensing.
Clause 21. The non-transitory computer-readable apparatus of any one of clauses 18-20 wherein the positive feasibility of sensing the target object comprises at least one of the requirements associated with the one or more RF sensing metrics meeting or exceeding a prescribed threshold.
Clause 22. The non-transitory computer-readable apparatus of any one of clauses 18-21 wherein the information relating to the one or more RF sensing metrics comprises error values for the one or more RF sensing metrics.
Clause 23. The non-transitory computer-readable apparatus of any one of clauses 18-22 wherein the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object.
Clause 24. The non-transitory computer-readable apparatus of any one of clauses 18-23 wherein the plurality of instructions are further configured to, when executed by the one or more processors, cause the sensing UE to: measure a signal quality parameter, and determine a ranging estimation error associated with the target object based at least on the measured signal quality parameter.
Clause 25. A sensing user equipment (UE) comprising: means for receiving a sensing feasibility report configuration from a base station, the sensing feasibility report configuration comprising requirements associated with one or more radio frequency (RF) sensing metrics; means for detecting signal interference based on communication between the base station and a communication UE; means for generating a sensing feasibility report comprising information relating to the one or more RF sensing metrics given the signal interference and indicating a feasibility of sensing a target object; and means for sending the sensing feasibility report to the base station.
Clause 26. The sensing UE of clause 25, further comprising: based on the feasibility of sensing the target object indicating a positive feasibility of sensing the target object: means for receiving an RF sensing reference signal originating from the base station; means for, based on the RF sensing reference signal, determining an estimated sensing metric associated with the target object; and means for sending a sensing result report to the base station, the sensing result report comprising estimated sensing metric.
Clause 27. The sensing UE of any one of clauses 25-26 wherein the positive feasibility of sensing the target object comprises one of a binary determination of feasibility of sensing, or at least one of the requirements associated with the one or more RF sensing metrics meeting or exceeding a prescribed threshold.
Clause 28. The sensing UE of any one of clauses 25-27 wherein the information relating to the one or more RF sensing metrics comprises error values for the one or more RF sensing metrics.
Clause 29. The sensing UE of any one of clauses 25-28 wherein the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object.
Clause 30. The sensing UE of any one of clauses 25-29 further comprising means for measuring a signal quality parameter; and means for determining a ranging estimation error associated with the target object based at least on the measured signal quality parameter; wherein the signal quality parameter comprises a signal-to-noise ratio (SNR) or a Signal to Interference & Noise Ratio (SINR).

What is claimed is:

1. A method of determining a feasibility of sensing a target object in a radio frequency (RF) sensing system having a communication user equipment (UE) and a sensing UE, the method comprising:
sending or receiving a communication signal with the communication UE, the sending or the receiving of the communication signal causing signal interference with the sensing UE;
sending to the sensing UE a sensing feasibility report configuration, the sensing feasibility report configuration comprising requirements associated with one or more RF sensing metrics;
receiving from the sensing UE a sensing feasibility report, the sensing feasibility report comprising information relating to the one or more RF sensing metrics given the signal interference; and
based on the information relating to the one or more RF sensing metrics indicating a positive feasibility of sensing the target object, sending an RF sensing reference signal toward the target object.

2. The method of claim 1, further comprising:
sending a sensing result report configuration to the sensing UE, the sensing result report configuration comprising the one or more RF sensing metrics; and
receiving a sensing result report from the sensing UE, the sensing result report comprising one or more estimations corresponding to the one or more RF sensing metrics based on the RF sensing reference signal.

3. The method of claim 1, wherein the positive feasibility of sensing the target object comprises one of a binary determination of feasibility of sensing the target object.

4. The method of claim 1, wherein the positive feasibility of sensing the target object comprises at least one of the requirements associated with the one or more RF sensing metrics meeting or exceeding a prescribed threshold.

5. The method of claim 1, wherein the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object.

6. The method of claim 5, wherein the one or more RF sensing metrics associated with the target object are based at least on a signal quality parameter measured by the sensing UE.

7. The method of claim 1, wherein the information relating to the one or more RF sensing metrics comprises one or more corresponding estimation error values for the one or more RF sensing metrics associated with the target object.

8. The method of claim 1, wherein:
the sending of the communication signal with the communication UE comprises sending a downlink reference signal to the communication UE; and
the receiving of the communication signal with the communication UE comprises receiving an uplink reference signal from the communication UE.

9. The method of claim 1, wherein:
the sending of the sensing feasibility report configuration comprises sending the sensing feasibility report configuration to a plurality of sensing UEs;
the sensing feasibility report configuration comprises a plurality of profiles each defining one or more different requirements associated with at least a portion of the one or more RF sensing metrics; and
the method further comprises selecting one or more of the plurality of sensing UEs for sensing the target object, the selecting based on the one or more different requirements indicating a sensing feasibility of the selected one or more of the plurality of sensing UEs.

10. A wireless base station comprising:
a transceiver configured to perform data communication with a communication user equipment (UE) and a sensing UE;
memory; and
one or more processors communicatively coupled to the transceiver and the memory, and configured to:
send or receive a communication signal with the communication UE, the sending or the receiving of the communication signal causing signal interference with the sensing UE;
send to the sensing UE a sensing feasibility report configuration, the sensing feasibility report configuration comprising requirements associated with one or more radio frequency (RF) sensing metrics;
receive from the sensing UE a sensing feasibility report, the sensing feasibility report comprising information relating to the one or more RF sensing metrics given the signal interference; and
based on the information relating to the one or more RF sensing metrics indicating a positive feasibility of sensing a target object, send an RF sensing reference signal toward the target object.

11. The wireless base station of claim 10, wherein the one or more processors are further configured to:
send a sensing result report configuration to the sensing UE, the sensing result report configuration comprising the one or more RF sensing metrics; and
receive a sensing result report from the sensing UE, the sensing result report comprising one or more estimations corresponding to the one or more RF sensing metrics based on the RF sensing reference signal.

12. The wireless base station of claim 10, wherein the positive feasibility of sensing the target object comprises one of a binary determination of feasibility of sensing the target object.

13. The wireless base station of claim 10, wherein the positive feasibility of sensing the target object comprises at least one of the requirements associated with the one or more RF sensing metrics meeting or exceeding a prescribed threshold.

14. The wireless base station of claim 10, wherein:
the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object and based at least on a signal quality parameter measured by the sensing UE; and
the signal quality parameter comprises a signal-to-noise ratio (SNR) or a Signal to Interference & Noise Ratio (SINR).

15. The wireless base station of claim 10, wherein the information relating to the one or more RF sensing metrics comprises one or more corresponding estimation error values for the one or more RF sensing metrics associated with the target object.

16. The wireless base station of claim 10, wherein:
the sending of the communication signal with the communication UE comprises sending of a downlink reference signal to the communication UE; and
the receipt of the communication signal with the communication UE comprises receipt of an uplink reference signal from the communication UE.

17. The wireless base station of claim 10, wherein:
the sending of the sensing feasibility report configuration comprises sending of the sensing feasibility report configuration to a plurality of sensing UEs;
the sensing feasibility report configuration comprises a plurality of profiles each defining one or more different requirements associated with at least a portion of the one or more RF sensing metrics; and
the one or more processors are further configured to select one or more of the plurality of sensing UEs for sensing the target object, the selection based on the one or more different requirements indicating a sensing feasibility of the selected one or more of the plurality of sensing UEs.

18. A non-transitory computer-readable apparatus comprising a storage medium, the storage medium comprising a plurality of instructions configured to, when executed by one or more processors, cause a sensing user equipment (UE) to:
receive a sensing feasibility report configuration from a base station, the sensing feasibility report configuration comprising requirements associated with one or more radio frequency (RF) sensing metrics;
detect signal interference based on communication between the base station and a communication UE;
generate a sensing feasibility report comprising information relating to the one or more RF sensing metrics given the signal interference and indicating a feasibility of sensing a target object; and
send the sensing feasibility report to the base station.

19. The non-transitory computer-readable apparatus of claim 18, wherein the plurality of instructions are further configured to, when executed by the one or more processors, cause the sensing UE to:
based on the feasibility of sensing the target object indicating a positive feasibility of sensing the target object:
receiving an RF sensing reference signal originating from the base station;
based on the RF sensing reference signal, determining an estimated sensing metric associated with the target object; and
sending a sensing result report to the base station, the sensing result report comprising estimated sensing metric.

20. The non-transitory computer-readable apparatus of claim 19, wherein the positive feasibility of sensing the target object comprises one of a binary determination of feasibility of sensing.

21. The non-transitory computer-readable apparatus of claim 19, wherein the positive feasibility of sensing the target object comprises at least one of the requirements associated with the one or more RF sensing metrics meeting or exceeding a prescribed threshold.

22. The non-transitory computer-readable apparatus of claim 18, wherein the information relating to the one or more RF sensing metrics comprises error values for the one or more RF sensing metrics.

23. The non-transitory computer-readable apparatus of claim 18, wherein the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object.

24. The non-transitory computer-readable apparatus of claim 18, wherein the plurality of instructions are further configured to, when executed by the one or more processors, cause the sensing UE to: measure a signal quality parameter, and determine a ranging estimation error associated with the target object based at least on the measured signal quality parameter.

25. A sensing user equipment (UE) comprising:
means for receiving a sensing feasibility report configuration from a base station, the sensing feasibility report configuration comprising requirements associated with one or more radio frequency (RF) sensing metrics;
means for detecting signal interference based on communication between the base station and a communication UE;
means for generating a sensing feasibility report comprising information relating to the one or more RF sensing metrics given the signal interference and indicating a feasibility of sensing a target object; and
means for sending the sensing feasibility report to the base station.

26. The sensing UE of claim 25, further comprising:
based on the feasibility of sensing the target object indicating a positive feasibility of sensing the target object:
means for receiving an RF sensing reference signal originating from the base station;
means for, based on the RF sensing reference signal, determining an estimated sensing metric associated with the target object; and
means for sending a sensing result report to the base station, the sensing result report comprising estimated sensing metric.

27. The sensing UE of claim 26, wherein the positive feasibility of sensing the target object comprises one of a binary determination of feasibility of sensing, or at least one of the requirements associated with the one or more RF sensing metrics meeting or exceeding a prescribed threshold.

28. The sensing UE of claim 25, wherein the information relating to the one or more RF sensing metrics comprises error values for the one or more RF sensing metrics.

29. The sensing UE of claim 25, wherein the one or more RF sensing metrics comprise a miss-detection ratio, a false-alarm ratio, a ranging estimation error, a distance estimation error, a speed estimation error, a Doppler frequency estimation error, a micro-Doppler frequency estimation error, or a combination thereof, each of the one or more RF sensing metrics associated with the target object.

30. The sensing UE of claim 25, further comprising:
means for measuring a signal quality parameter; and
means for determining a ranging estimation error associated with the target object based at least on the measured signal quality parameter;
wherein the signal quality parameter comprises a signal-to-noise ratio (SNR) or a Signal to Interference & Noise Ratio (SINR).
